(19) United States
(12) Patent Application Publication
(10) Pub. No.: US 2025/0063445 A1
(43) Pub. Date: Feb. 20, 2025

(54) METHODS, COMMUNICATIONS DEVICES, AND INFRASTRUCTURE EQUIPMENT

(71) Applicant: Sony Group Corporation, Tokyo (JP)

(72) Inventors: Vivek SHARMA, Basingstoke (GB); Yuxin WEI, Basingstoke (GB); Yassin Aden AWAD, Basingstoke (GB); Hideji WAKABAYASHI, Basingstoke (GB)

(73) Assignee: Sony Group Corporation, Tokyo (JP)

(21) Appl. No.: 18/723,464

(22) PCT Filed: Dec. 12, 2022
(86) PCT No.: PCT/EP2022/085337

§ 371 Date: Jun. 24, 2024

(30) Foreign Application Priority Data
Jan. 5, 2022 (EP) 22150369.1

(51) Int. Cl. H04W 36/00; H04L 5/00; H04W 88/04

(52) U.S. Cl. CPC H04W 36/033; H04L 5/0048; H04W 88/04

(57) ABSTRACT

A method comprising determining that a communications device is to switch from a first path of communications with infrastructure equipment to a second path of communications with the infrastructure equipment, wherein the second path comprises a relay node for relaying signals between the communications device and the infrastructure equipment, receiving a signal comprising an indication of one or more of a plurality of wireless communications networks that are supported by the relay node of the second path, determining, based on the received indication, if a first wireless communications network is among the one or more wireless communications networks that are supported by the relay node of the second path, and switching, if the first wireless communications network is among the one or more wireless communications networks that are supported by the relay node of the second path, from the first path to the second path.

### BACKGROUND

### Field of Disclosure

The present disclosure relates generally to communications devices and infrastructure equipment operating in wireless communications networks, and specifically to path switch procedures performed in such wireless communications networks.

The present application claims the Paris Convention priority from European patent application number EP22150369.1, filed on 5 Jan. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communications devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles. The connectivity of devices is conventionally maintained through the use of so-called “path switching” procedures (such as handover) where a communications device changes its access point to a wireless communications network or its path to a particular access point (with respect to various relay nodes) in response to an instruction from the wireless communications network or in response to one or more conditions being met. In view of the wide range device types and capabilities in future wireless communications networks, there is a need for improved path switching procedures.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a first wireless communications network via an infrastructure equipment supporting radio access network, RAN, sharing between a plurality of wireless communications networks comprising the first wireless communications network. The method comprises determining that the communications device is to switch from a first path of communications with the infrastructure equipment to a second path of communications with the infrastructure equipment, wherein the second path comprises a relay node for relaying signals between the communications device and the infrastructure equipment, receiving a signal comprising an indication of one or more of the plurality of wireless communications networks that are supported by the relay node of the second path, determining, based on the received indication, if the first wireless communications network is among the one or more wireless communications networks that are supported by the relay node of the second path, and switching, if the first wireless communications network is among the one or more wireless communications networks that are supported by the relay node of the second path, from the first path to the second path.

Embodiments of the present technique, which in addition to methods of operating communications devices, also relate to communications devices, infrastructure equipment, methods of operating infrastructure equipment, and circuitry for communications devices and infrastructure equipment, allow for the more efficient performance of path switching procedures by communications devices in wireless communications networks.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure:

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents aspects of a conventional handover procedure;

FIGS. 5A and 5B are reproduced from [6], and show legacy message procedures for, respectively. remote UE switching to direct Uu cell, and remote UE switching to indirect relay UE;

FIG. 6 is a part schematic representation, part message flow diagram of communications between a communications device and an infrastructure equipment forming part of a wireless communications network in accordance with embodiments of the present technique;

FIG. 7 illustrates a scenario where different relays support different public land mobile networks (PLMNs) in accordance with embodiments of the present technique;

FIG. 8 shows an example of a message sequence when a relay UE discovery message includes an indication of all shared PLMNs supported by that relay UE in accordance with embodiments of the present technique;

FIG. 9 shows an example of a message sequence when a relay UE discovery message includes an indication of only the serving PLMN of that relay UE in accordance with embodiments of the present technique; and

FIG. 10 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

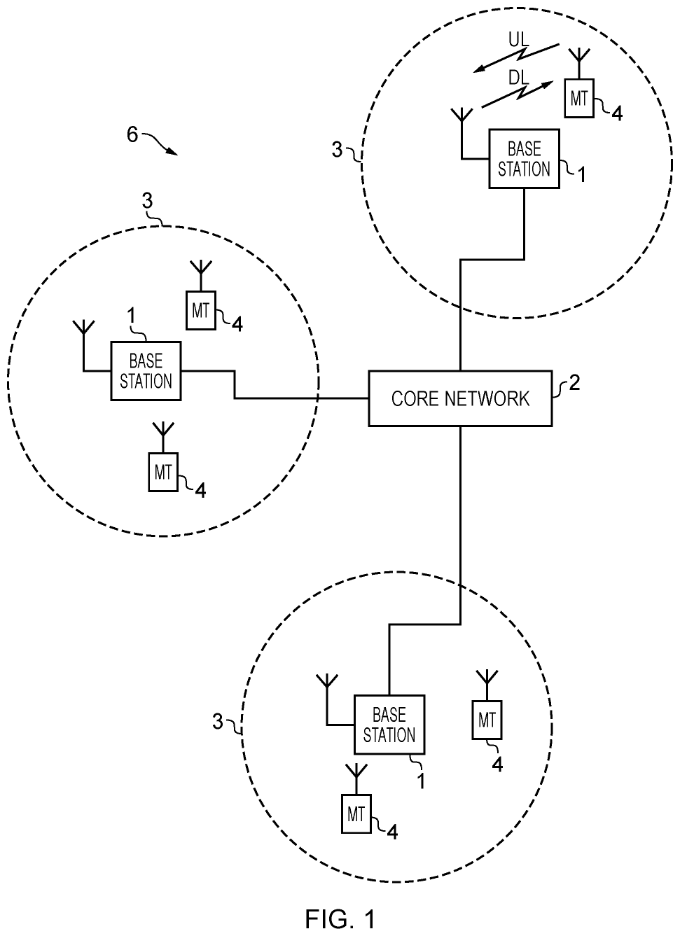

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H, and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network (RAN).

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

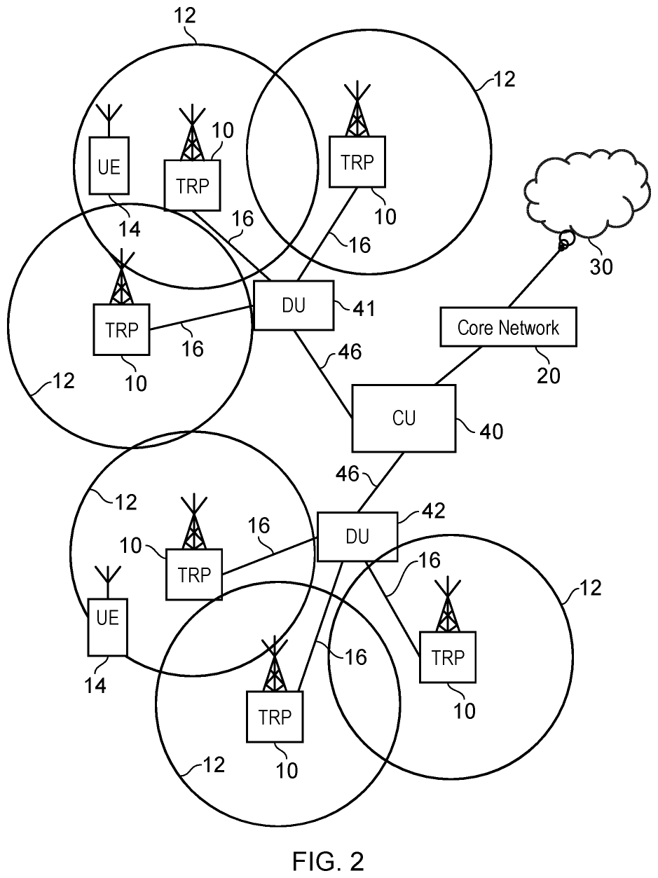

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network 20 infrastructure equipment may comprise a control unit/controlling node 40 and/or a TRP 10 of the kind shown in FIG. 2 which is adapted to provide functionality in accordance with the principles described herein.

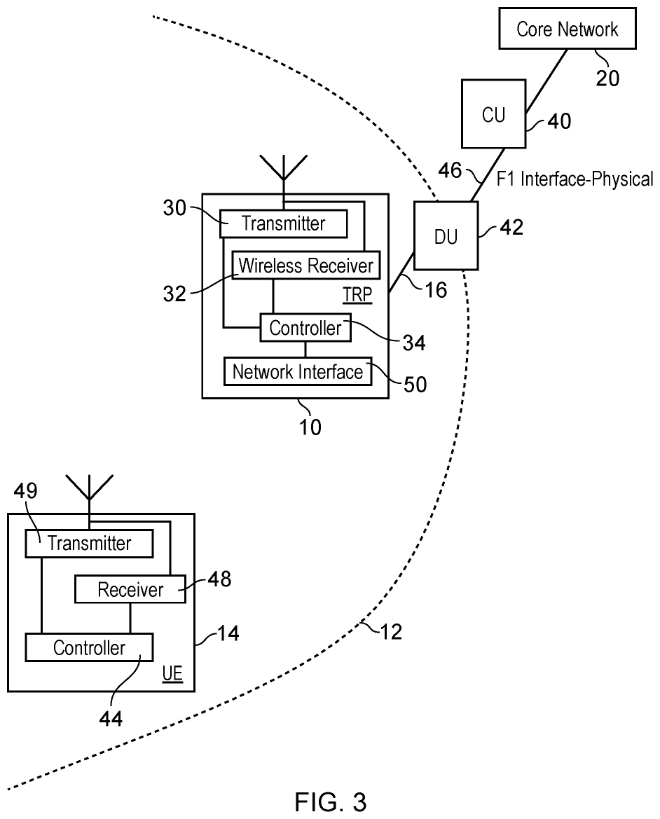

A more detailed diagram of some of the components of the network shown in FIG. 2 is provided by FIG. 3. In FIG. 3, a TRP 10 such as that shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

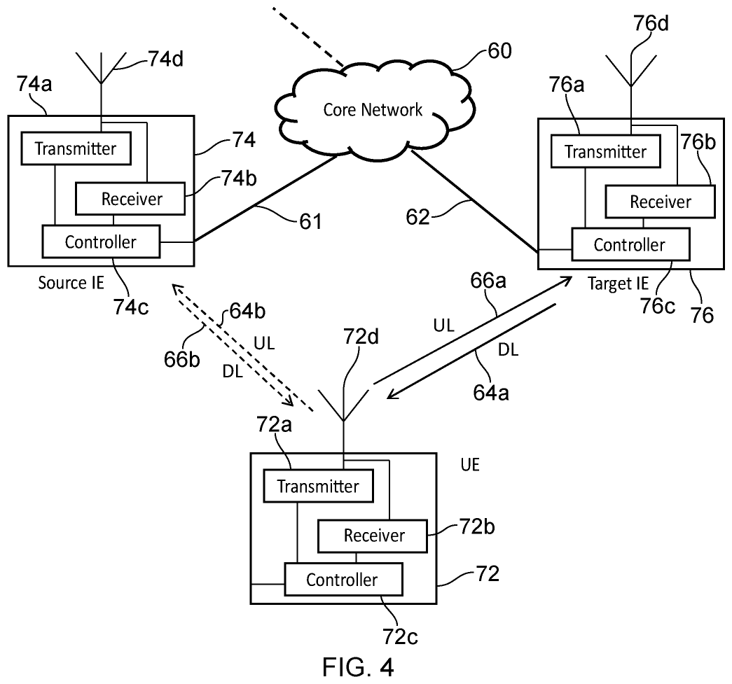

A detailed illustration of a wireless communications network in which a handover may be performed is shown in FIG. 4. As will be appreciated from FIG. 4, a communications device 72 is handed over from a source infrastructure equipment 74 to a target infrastructure equipment 76 forming part of a radio access network to a core network 60. As will be appreciated the communications device 72 is an example of a communications device such as the communications device 14 of FIGS. 1, 2 and 3. The communications device 72 may be a UE in one example.

Before the handover, the communications device 72 transmits signals on an uplink UL and receive signals on a downlink DL from a source infrastructure equipment 74. The source infrastructure equipment 74 and the target infrastructure equipment 76 may each be thought of as a gNB 1 as shown in FIG. 1 or a combination of a controlling node 40 and TRP 10 as shown in FIGS. 2 and 3. Before the handover, the communications device 72 is shown to transmit uplink data to the source infrastructure equipment 74 via uplink resources UL of a wireless access interface as illustrated generally by dashed arrow 64b to the source infrastructure equipment 74. The communications device 72 may similarly be configured to receive downlink data transmitted by the source infrastructure equipment 74 via downlink resources DL as indicated by dashed arrow 66b from the source infrastructure equipment 74 to the communications device 72. After the handover, the communications device 72 is shown to transmit uplink data to the target infrastructure equipment 76 via uplink resources UL of a wireless access interface as illustrated generally by solid arrow 66a to the target infrastructure equipment 76. The communications device 72 may similarly be configured to receive downlink data transmitted by the target infrastructure equipment 76 via downlink resources DL as indicated by solid arrow 64a from the target infrastructure equipment 76 to the communications device 72.

In FIG. 4, the source and target infrastructure equipment 74, 76 are each connected to a core network 60 via interfaces 61, 62 to a controller 74c, 76c of the respective infrastructure equipment 74. The source and target infrastructure equipment 74, 76 each include a receiver 74b, 76b connected to an antenna 74d, 76d and a transmitter 74a, 76a connected to the antenna 74d, 76d. Correspondingly, the communications device 72 includes a controller 72c connected to a receiver 72b which receives signals from an antenna 72d and a transmitter 72a also connected to the antenna 72d.

The controllers 74c, 76c are configured to control the source and target infrastructure equipment 74, 76 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 74c, 76c may comprise circuitry which is suitably configured/programmed to provide the desired functionality using conventional programming/configuration techniques for equipment in wireless telecommunications systems. The transmitters 74a, 76a and the receivers 74b, 76b may comprise signal processing and radio frequency filters, amplifiers and circuitry in accordance with conventional arrangements. The transmitters 74a, 76a the receivers 74b, 76b and the controllers 74c, 76c are schematically shown in FIG. 4 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 74 will in general comprise various other elements associated with its operating functionality.

Correspondingly, the controller 72c of the communications device 72 is configured to control the transmitter 72a and the receiver 72b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 72c may comprise circuitry which is suitably configured/programmed to provide the desired functionality using conventional programming/configuration techniques for equipment in wireless telecommunications systems. Likewise, the transmitter 72a and the receiver 72b may comprise signal processing and radio frequency filters, amplifiers and circuitry in accordance with conventional arrangements. The transmitters 72a, receivers 72b, and controllers 72c are schematically shown in FIG. 4 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 72 will in general comprise various other elements associated with its operating functionality, for example a power source, user interface, and so forth, but these are not shown in FIG. 4 in the interests of simplicity.

The controllers 74c, 72c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Sidelink Relay

As mentioned above, the introduction of a wide range of new device types and capabilities in NR creates technical challenges in maintaining device connectivity with a wireless communications network. One aspect of NR currently under development of the 3GPP group is that of the sidelink relay, which is discussed in 3GPP Release-17. For example, 3GPP study item [3] discusses a single-hop NR sidelink-based relay. In particular, [3] targets:
Study mechanism(s) with minimum specification impact to support Service and System Aspect (SA) requirements for sidelink-based UE-to-network and UE-to-UE relay, focusing on the following aspects (if applicable) for layer-3 relay and layer-2 relay [RAN2];
   Relay (re-)selection criterion and procedure;
   Relay/Remote UE authorization;
   QoS for relaying functionality;
   Service continuity;
   Security of relayed connection after SA3 has provided its conclusions; and
   Impact on user plane protocol stack and control plane procedure, e.g., connection management of relayed connection; and
Study mechanism(s) to support upper layer operations of discovery model/procedure for sidelink relaying, assuming no new physical layer channel/signal [RAN2].

It is noted in [3] that it is expected that UE-to-network relays and UE-to-UE relays will use the same relaying solution, and that forward compatibility for multi-hop relay support in future releases of standards should be taken into account. It is also noted in [3] that, for layer-2 UE-to-network relays, the architecture of end-to-end Packet Data Convergence Protocol (PDCP) and hop-by-hop Radio Link Control (RLC), as recommended in [4], is taken as a starting point.

Enhancements for sidelink relays in NR are discussed in [5], for example, which defines objectives relating to sidelink relay enhancement including the specifying of mechanisms for enhancement of service continuity for single-hop layer-2 UE-to-network relays for the following scenarios [RAN2, RAN3]:
A. Inter-gNB indirect-to-direct path switching (i.e., “UE 1<->relay UE A<->gNB X” to “UE 1<->gNB Y”)
B. Inter-gNB direct-to-indirect path switching (i.e., “UE 1<->gNB X” to “UE 1<->relay UE A<->gNB Y”)
C. Intra-gNB indirect-to-indirect path switching (i.e., “UE 1<->relay UE A<->gNB X” to “UE 1<->relay UE B<->gNB X”)
D. Inter-gNB indirect-to-indirect path switching (i.e., “UE1<->relay UE A<->gNB X” to “UE1<->relay UE B<->gNB Y”)

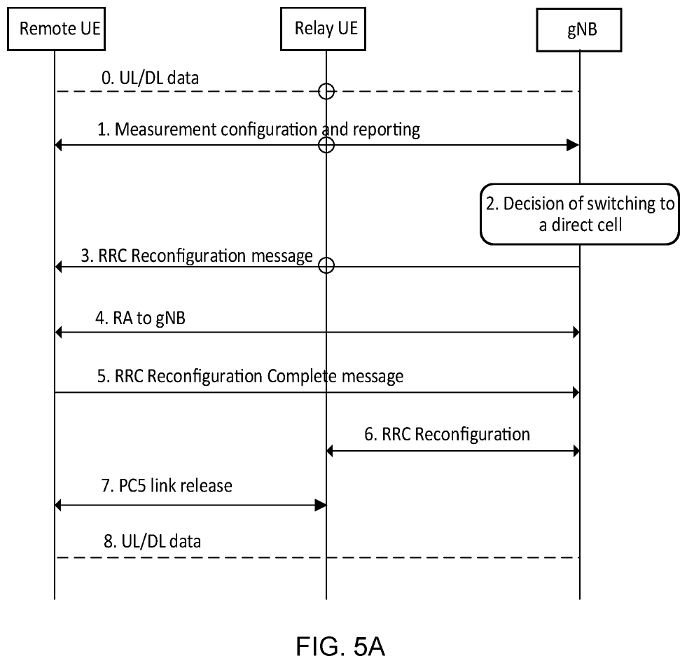

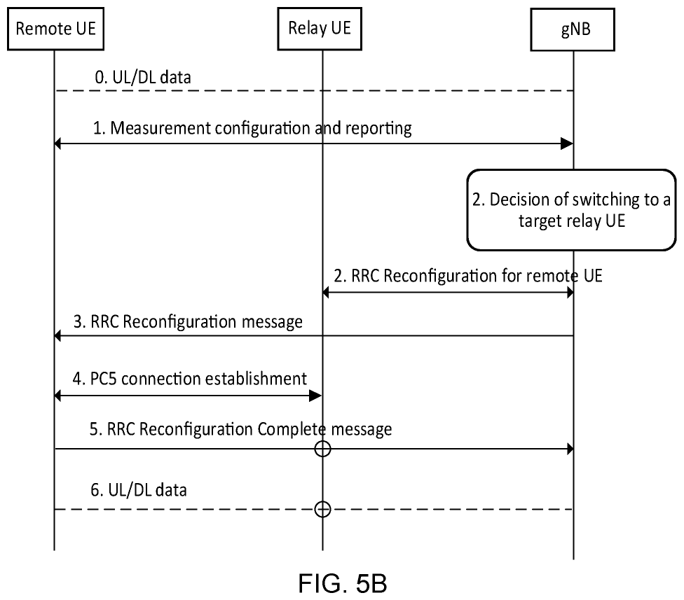

It is noted in [5] that scenario D as defined above is to be supported by reusing solutions for the other scenarios (i.e. A to C as defined above) without specific optimisations. FIGS. 5A and 5B, which are reproduced from [6] and which can be more fully understood through reference to [6] respectively show example message procedures for remote UE switching to direct Uu cell (FIG. 5A) and for remote UE switching to indirect really UE (FIG. 5B).

RAN sharing, where RAN resources and infrastructure are shared between multiple mobile operators to mutually increase coverage and network availability, is a solution that has been discussed—but not yet agreed—within 3GPP as something that could be extended from network infrastructure equipment to relays as well. That is, it is envisaged that some relay nodes and relay UEs could feasibly support multiple different public land mobile networks (PLMNs) at the same time, offering connectivity (via their serving gNBs) to each of these PLMNs. The possibility of RAN sharing by relays is discussed in [7], for example.

In [6], various options are proposed for how the PLMNs supported by a particular relay may be signalled to a UE, including signalling the PLMN IDs in the relay discovery message, or in a radio resource control (RRC) broadcast signal from the gNB. However, discussion and consideration of these options in [7] is focussed on how to support RAN sharing for sidelink relays and remote UEs for accessing the serving sidelink relay. A problem identified by the present inventors is how it can be known by a remote UE whether a target relay UE (which is the target of a path switching procedure to be performed by the remote UE) supports the remote UE's home PLMN. That is, how can it determined by the remote UE what the supported PLMNs of a particular target relay node are, before a remote UE connects to that target relay node during mobility procedures: specifically during the performance of direct-to-indirect and indirect-to-indirect path switching or handover procedures by a UE. Embodiments of the present disclosure propose solutions to such a problem.

### Service Continuity for RAN Sharing Scenarios Involving Sidelink Relays

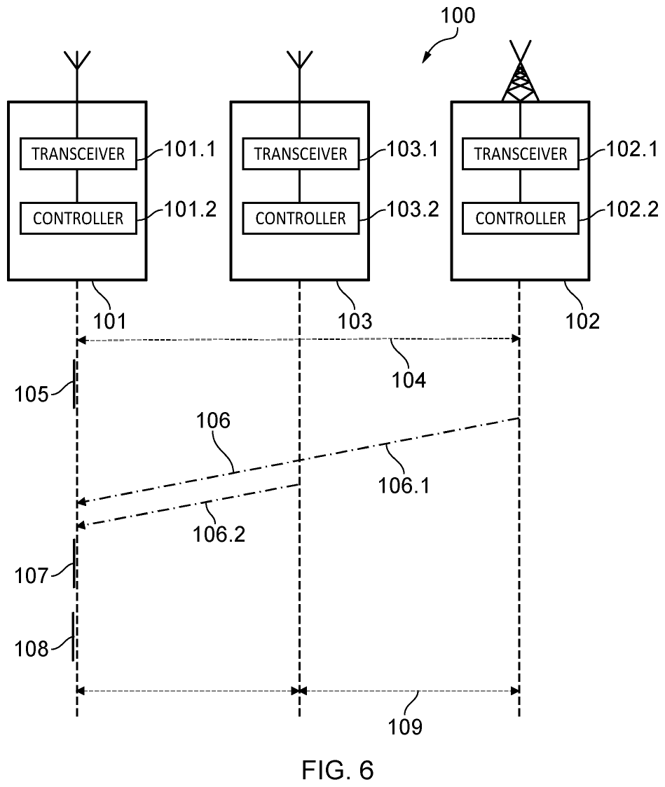

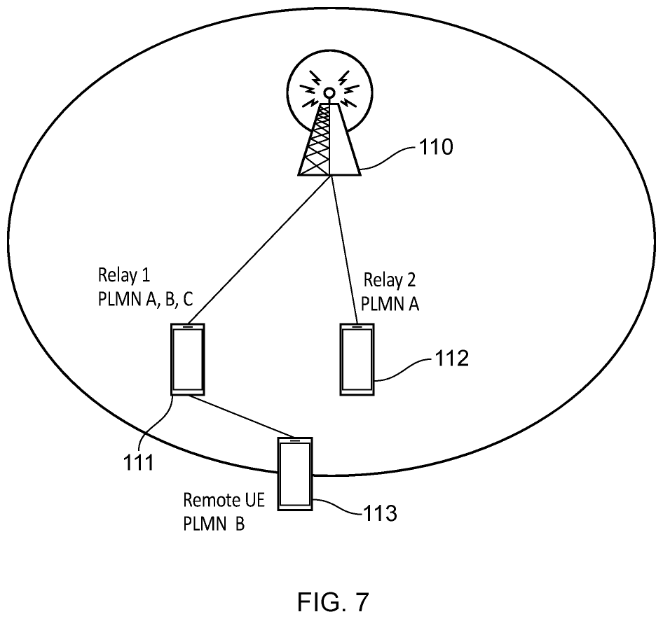

FIG. 6 provides a part schematic representation, part message flow diagram of communications within a wireless communications system 100 between a communications device or UE 101 and a wireless communications network in accordance with embodiments of the present technique. The wireless communications network may include an infrastructure equipment 102 which provides and controls a first cell having a coverage area within in one of which the communications device 101 may be located, or may enter in and out of, wherein the infrastructure equipment 102 supports radio access network, RAN, sharing between a plurality of wireless communications networks. The wireless communications network may also include one or more relay nodes 103 for relaying signals between the communications device 101 and the infrastructure equipment 102. The communications device 101 comprises a transceiver (or transceiver circuitry) 101.1 configured to transmit signals to and/or receive signals from the wireless communications network (for example, to the infrastructure equipment 102 via a wireless access interface provided by the wireless communications network), or indeed from other wireless communications networks. As can be seen in FIG. 7, the infrastructure equipment 102 and the relay nodes 103 may also comprise transceivers (or transceiver circuitry) 102.1, 103.1 which may be configured to transmit signals to and/or receive signals from the communications device 101 via the wireless access interface and/or from each other, and controllers (or controller circuitry) 102.2, 103.2, which may be configured to control the transceiver circuitry 102.1, 103.1 to transmit or to receive the signals. Each of the controllers 101.2, 102.2, 103.2 may be, for example, a microprocessor, a CPU, or a dedicated chipset, etc.

The controller circuitry 101.2 of the communications device 101 is configured in combination with the transceiver circuitry 101.1 of the communications device 101 to determine that the communications device 101 is to switch from a first path 104 of communications with the infrastructure equipment 102 to a second path 109 of communications with the infrastructure equipment 102, wherein the second path comprises a relay node 103 for relaying signals between the communications device 101 and the infrastructure equipment 102 (though the first path may also comprise a relay node), to receive 106 a signal comprising an indication of one or more of the plurality of wireless communications networks that are supported by the relay node 103 of the second path 109 (where this signal may be, for example. received 106.1 from the infrastructure equipment 102, or received 106.2 from the relay node 103 of the second path 109), to determine 107, based on the received indication 106, if the first wireless communications network is among the one or more wireless communications networks that are supported by the relay node 103 of the second path 109, and to switch 108, if the first wireless communications network is among the one or more wireless communications networks that are supported by the relay node 103 of the second path 109, from the first path 104 to the second path 109.

Essentially, embodiments of the present technique propose that a UE is able to determine, before connecting to a new relay node as part of a path switching procedure, whether that new target relay node supports the UE's home PLMN. This is of particular importance when RAN sharing techniques are employed, as the relay node may support one or multiple PLMNs, but not necessarily the UE's serving/home PLMN. If the UE connects to a relay node that does not support it's home PLMN, then the UE will not be able to exchange signalling or data with its home PLMN through that relay node, and will be required to perform another path switching procedure in order to do so, which is an inefficient use of resources and time. In essence, at least some embodiments of the present technique can be considered to be a hybrid combination of the legacy indirect-to-direct switching and direct-to-indirect switching procedures as shown in FIGS. 5A and 5B as discussed above.

FIG. 7 shows an example scenario where different relays support different PLMNs in accordance with embodiments of the present disclosure. In the example of FIG. 7, the cell of gNB 110 supports RAN sharing, and broadcasts three PLMNs; PLMN A, PLMN B, and PLMN C. Similarly a first relay UE 111 supports all of these PLMNs; PLMN A, PLMN B, and PLMN C. However, a second relay UE 112 supports only the home PLMN (in this case PLMN A) for relaying purposes. The support of multiple PLMNs or only the home PLMN may depend on the contract between the user of the relay UEs and the operator(s) of the PLMN(s), and/or on the capabilities or deployment options of the relay UEs. For example. PLMN B relays may be configured to only support their home PLMN—i.e. PLMN B—for relaying purposes.

In the example of FIG. 7, a remote UE 113 may belong to PLMN B and may be connected indirectly via the first relay UE 111 to the gNB 110 as an initial condition (i.e. via the first path—though the first path may alternatively relate to in other examples of embodiments of the present technique direct communication between the remote UE 113 and the gNB 110). After a period of time, the remote UE 113 may move away from the first relay UE 111, and may encounter the second relay UE 11, from which it may receive reference or discovery signals which have a higher detectable reference signal received power (RSRP) or the like. Here, the remote UE 113 has a few options upon encountering the second relay UE 112—via which it may intend to communicate with the gNB 110 via the second path by performing a path switch as described above with reference to FIG. 6.

The remote UE 113 may detect a discovery signal from the second relay UE 112 upon encountering it, and in accordance with embodiments of the present technique, that the discovery message will include an indication of the supported PLMNs—or at least of the home PLMN—of the second relay UE 112. So, for the purposes of RAN sharing, if the discovery message includes all supported PLMNs, then the first relay UE 111 would have included PLMN A, PLMN B, and PLMN C in its discovery message, and the remote UE 113 would have selected the first relay UE 111 in order to form an indirect path to the gNB 110, as the first relay UE 111 supports the remote UE's 113 home PLMN B. In this case, the discovery message transmitted by the relay UEs 111, 112 may include PLMN ID(s) either directly in the message or within an RRC container inside the discovery message. In other words, the communications device may be configured to receive, from the relay node of the second path, a discovery signal, wherein the discovery signal comprises the indication of the one or more wireless communications networks that are supported by the relay node of the second path. Here, the indication of the one or more wireless communications networks that are supported by the relay node of the second path may be comprised within a radio resource control, RRC, container of the discovery signal.

For mobility use cases, such as those described in the present application and addressed by embodiments of the present technique, including the PLMN ID(s) in the discovery message is straightforward for the remote UE 113 to decode. If the PLMN ID(s) are included in an RRC container and the RRC container is included in the discovery message, then more effort will be required for the remote UE 113 to decode and identify the PLMN ID(s). This additional processing when PLMN ID(s) are stored in an RRC container is required for each potential target relay UE. For the second relay UE 112 in the example of FIG. 7, its discovery message will contain PLMN A only. So, in this case, the remote UE 113 has the following options:
The remote UE 113 may not report the second relay UE 112 to the gNB 110 (in this case, the remote UE 113 benefits from reduced overheads due to not being required to signal reports for relay UEs which do not support its PLMN. However, the gNB 110 may find it difficult to know of any coverage holes or interference caused to PLMN B subscribers due to the second relay UE 112 not supporting PLMN B). In other words, the communications device may be configured to determine, if the first wireless communications network is not among the one or more wireless communications networks that are supported by the relay node of the second path, that the communications device is not to transmit an indication of the relay node of the second path to the infrastructure equipment;
The remote UE 113 may report the second Relay UE 112 to the gNB 110 along with the fact that the second relay UE 112 does not support its PLMN. In other words, the communications device may be configured to transmit, to the infrastructure equipment, if the first wireless communications network is not among the one or more wireless communications networks that are supported by the relay node of the second path, an indication of the relay node of the second path, where this transmitted indication of the relay node of the second path comprises an indication that the relay node of the second path does not support the first wireless communications network. This method allows the gNB 110 to be aware that the second relay UE 112 may cause interference or coverage holes for PLMN B users; or
The remote UE 113 may simply report the second relay UE 112 to the gNB 110. In other words, the communications device may be configured to transmit, to the infrastructure equipment, if the first wireless communications network is not among the one or more wireless communications networks that are supported by the relay node of the second path, an indication of the relay node of the second path. The gNB 110 should know the second relay UE's 112 supported PLMN(s) already, as these will be reported to the gNB 110 on the second relay UE 112 transitioning into a connected mode with the gNB 110 and becoming configured as a relay. Though this method is similar to that described in the second bullet above, the benefit of this approach is that the remote UE 113 does not need to perform a PLMN ID check, and may simply report the second relay UE 112 upon encountering it, e.g. via a PC5 RRC message to the first (i.e. current) relay UE 111 which then forwards the RRC message via the Uu interface to the gNB 110—this RRC message may be a new standalone RRC message or may be included in an existing message, e.g. piggybacked upon a measurement report. The remote UE 113 may simply report the second relay UE 112 without performing the PLMN ID check, even though it is not complicated for the remote UE 113 to check a relay's supported PLMN(s), and verify that its home PLMN is among them. However, an advantage of doing this does reduce the load of the remote UE 113 by at least a small amount through skipping PLMN ID checks for newly encountered relay UEs, while the remote UE 113 is also not necessarily required to decode the full contents of received discovery messages while performing sidelink-RSRP measurements based on that discovery message. In this case, the discovery message transmitted from the second relay UE 112 may or may not include an indication of the second relay UE's 112 supported PLMN IDs.

Since the remote UE 113 cannot connect to the second relay UE 112 to communicate with the gNB 110 since it doesn't support the remote UE's 113 home PLMN B, the remote UE 113 may, for example, find another relay (e.g. a third relay UE) supporting its PLMN, or may decide to remain with the first relay UE 111 if received signals are of a sufficient power or quality. In other words, the communications device may be configured to determine, if the first wireless communications network is not among the one or more wireless communications networks that are supported by the relay node of the second path, that the communications device is to switch from the first path to a third path of communications with the infrastructure equipment, wherein the third path comprises a second relay node for relaying signals between the communications device and the infrastructure equipment, the second relay node supporting the first wireless communications network.

Alternatively, the gNB 110 may trigger handover back to its own cell (i.e. the remote UE 113 will perform an indirect-to-direct path switch), or to another cell (operated by a second gNB) based on other measurements which are currently reported. In other words, the communications device may be configured either to receive from the infrastructure equipment, if the first wireless communications network is not among the one or more wireless communications networks that are supported by the relay node of the second path, an indication that the communications device is not to switch from the first path to the second path, or to receive from the infrastructure equipment, if the first wireless communications network is not among the one or more wireless communications networks that are supported by the relay node of the second path, an indication that the communications device is to perform a handover procedure from the infrastructure equipment to a second infrastructure equipment.

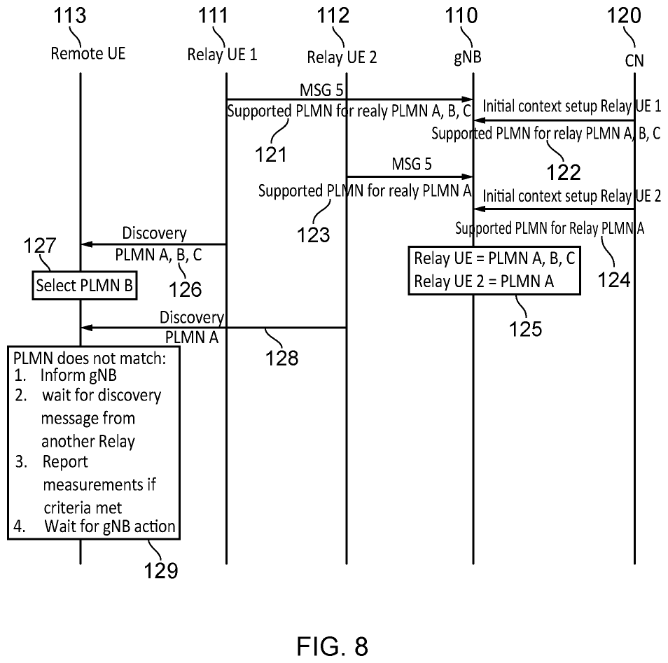

FIG. 8 shows an example of a message sequence when a relay UE discovery message includes an indication of all shared PLMNs supported by that relay UE in accordance with embodiments of the present technique, for example as described above in relation to the example shown by FIG. 7. As can be seen in FIG. 8, a first relay UE 111 may first transmit a signal 121 (e.g. msg 5 or UE capability) to the gNB 110 upon entering connected mode and being configured as a relay, where this signal 121 indicates all supported PLMNs for that first relay UE 111. In this case, the signal 121 indicates that the first relay UE 111 supports PLMN A, PLMN B, and PLMN C, as also shown in and described with respect to FIG. 7. Such supported PLMNs for the first relay UE 111 may additionally (or alternatively) be indicated to the gNB 110 from the core network 120 during the initial context setup 122 for the first relay UE 111. The same is done for the second relay UE 112, which may transmit a signal 123 (e.g. msg 5 or UE capability) to the gNB 110 upon entering connected mode and being configured as a relay, where this signal 123 indicates all supported PLMNs for that second relay UE 112, where in this case, the signal 123 indicates that the second relay UE 112 supports PLMN A only, as also shown in and described with respect to FIG. 7. Again, such supported PLMNs for the second relay UE 112 may additionally (or alternatively) be indicated to the gNB 110 from the core network 120 during the initial context setup 124 for the second relay UE 112. Either way, the gNB 110 now has stored knowledge 125 of the PLMNs supported by each of the first relay UE 111 and the second relay UE 112.

At a later point in time, the remote UE 113 wants to connect to the gNB 110, and so receives a discovery signal 126 from the first relay UE 111, as the remote UE 113 is located in the vicinity of that first relay UE 111. This discovery signal 126 may indicate that the first relay UE 111 supports each of PLMN A, PLMN B, and PLMN C, and since PLMN B is the remote UE's 113 home PLMN, the remote UE 113 is able to connect to the first relay UE 111 and select PLMN B. As described with respect to the example of FIG. 7, the remote UE 113 may then move away from the first relay UE 111, and towards the second relay UE 112. Here, the remote UE 113 may again receive a discovery signal 128 from this second relay UE 112, where this discovery signal 128 indicates that the second relay UE 112 supports only PLMN A. As this PLMN A does not match the remote UE's 113 home PLMN B, the UE 112 has several options as indicated by box 129 and described above. As shown by box 129, the remote UE 113 may either inform the gNB 110 of the second relay UE 112 (and optionally that the second relay UE 112 does not support the remote UE's 113 PLMN), or wait for a discovery message from another relay UE that indicates that that other relay UE does support the remote UE's 113 PLMN, report measurements to the gNB 110 if certain criteria are met (e.g. the RSRP of signals received from the first relay UE 110 are below a certain threshold), and/or wait for the gNB 110 to take action—i.e. based on the transmitted measurements from the remote UE 113, the transmitted indication of the second relay UE 112 by the remote UE 113, or the gNB's 110 knowledge 125 of the PLMNs supported by the second relay UE 112 and thus that the remote UE 113 is unable to communicate with the gNB 110 via the second relay UE 112.

In the examples of FIGS. 7 and 8, it is assumed that the discovery signal transmitted by a particular relay UE includes all RAN sharing PLMNs supported by that relay UE. However, in some arrangements of embodiments of the present disclosure, the discovery message may include only one PLMN (which may the home/serving PLMN of the relay UE or PLMN of the operator deploying the gNB). In other words, the one or more wireless communications networks that are indicated within the discovery signal as being supported by the relay node of the second path may be only a subset of a plurality of wireless communications networks that are supported by the relay node of the second path. Of course, those skilled in the art would appreciate that a relay UE's supported PLMN(s) or subset thereof may not be indicated within its discovery message at all. For example, such PLMN(s) or a subset thereof supported by a relay UE may be indicated to a remote UE by the gNB or by the core network, or the remote UE's access decision may be made by the gNB or the core network without the remote UE's involvement or awareness of the relay UE's supported PLMN ID.

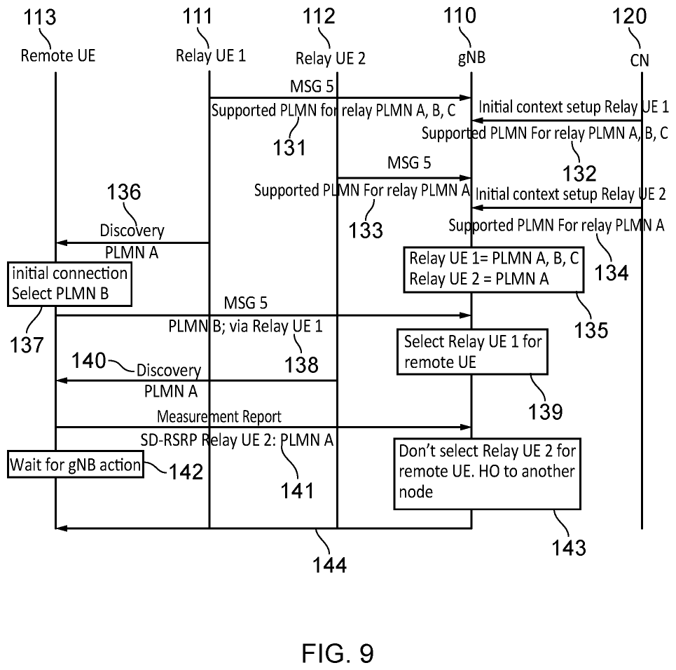

FIG. 9 shows an example of a message sequence when a relay UE discovery message includes an indication of only the serving PLMN of that relay UE in accordance with such embodiments of the present technique. The discovery signal may include an indication of only one PLMN so as to reduce the size of the discovery message, because in normal RAN sharing it can be the case that twelve PLMNs are shared, and including twelve PLMN IDs in every discovery signal may consume quite a large number of bits of that discovery signal. Up to a certain point, the example of FIG. 9 is similar to that of FIG. 8, with steps 131 to 135 of FIG. 9 corresponding exactly to steps 121 to 125 of FIG. 8, and so description of these steps will be omitted and can instead be understood from the description of FIG. 8 above.

However, at a point where the remote UE 113 wants to connect to the gNB 110, the discovery signal 136 received from the first relay UE 111 may indicate only that the first relay UE 111 supports PLMN A, when in fact the first relay UE 111 supports all of PLMN A, PLMN B, and PLMN C. While the remote UE 113 is not able to make a decision to form a connection with the gNB 110 via the first relay UE 111, as it is not aware that the first relay UE 111 supports its home PLMN B (which it selects as an initial condition 137), the remote UE 113 may instead transmit a signal 138 (e.g. a msg 5) via the first relay UE 111 indicating that the remote UE's 113 home PLMN is PLMN B. Alternatively (or in addition), the remote UE 113 may have included its PLMN in its discovery message and the first relay UE 111 is able to detect the remote UE's 113 PLMN ID from the received discovery message. The first relay UE 111 may then forward the remote UE's 113 PLMN ID to the gNB 110 so that the gNB 110 may be aware of the remote UE's 113 PLMN. The first relay UE 111 may forward the remote UE's 113 PLMN ID either before or after verifying the received PLMN ID with its operational list of PLMN IDs. In the case there is no match between the received PLMN ID of the remote UE 113 and the operational list of PLMN IDs at the first relay UE 111, the first relay UE 111 may send a discovery reject message, and also inform gNB 110 of this. Those skilled in the art would appreciate that the second relay UE 112 may operate in this same or a similar manner should it receive the discovery message from the remote UE 113.

Since the gNB 110 has knowledge 135 that the first relay UE 111 supports PLMB B, it can select 139 the first relay UE 111 for the remote UE 113, and so the remote UE 113 is then able to communicate with the gNB 110 via the first relay UE 111. This selection may then be indicated by the gNB 110 to the remote UE 113, either based on a decision by the gNB or on a query received by the remote UE 113 as to the other PLMNs supported by the first relay UE 111—this indication is not shown in the example of FIG. 9.

Again as described with respect to the examples of FIGS. 7 and 8, the remote UE 113 may then move away from the first relay UE 111, and towards the second relay UE 112. Here, the remote UE 113 may again receive a discovery signal 140 from this second relay UE 112, where this discovery signal 140 may only indicate that the second relay UE 112 supports only PLMN A or the PLMN list in the discovery message is empty (which is in fact the only PLMN that the second relay UE 112 supports in this example). Since the remote UE 113 is unaware as to whether it can connect to the gNB 110 via the second relay UE 112, it may transmit a measurement report 141 to the gNB 110, where this measurement report 141 indicates some measurements (e.g. RSRP) of signals received from the second relay UE 112.

Again, the other PLMNs that are supported by the second relay UE 112 may be indicated (not shown in FIG. 9) by the gNB (instead of or in addition to a discovery signal 140) either based on a decision by the gNB or on a query received by the remote UE 113. In other words, the communications device may be configured to receive, from the infrastructure equipment, the indication of the one or more wireless communications networks that are supported by the relay node of the second path, where the communications device may be configured to receive reference signals from the relay node of the second path, to perform one or more measurements on the received reference signals, to transmit an indication of the performed one or more measurements to the infrastructure equipment, and to receive, in response to the transmitted indication of the performed one or more measurements, the indication of the one or more wireless communications networks that are supported by the relay node of the second path. Here, the transmitted indication of the performed one or more measurements may comprise a query by the communications device of the one or more wireless communications networks that are supported by the relay node of the second path. The indication of the one or more wireless communications networks that are supported by the relay node of the second path transmitted by the infrastructure equipment to the communications device may be based on an indication of such wireless communications networks that are supported by the relay node of the second path previously received by the infrastructure equipment from the core network—i.e. in step 134 in the example of FIG. 9.

The remote UE 113 may then wait 142 for the gNB 110 to take action on the basis of this transmitted measurement report 141. The gNB 110, upon receiving the measurement report 141, may determine 143 (based on its knowledge 135) that the second relay UE 112 does not support the remote UE's home PLMN B, and so may determine that the remote UE 113 should not select the second relay UE 112 but instead should either stay with the first relay UE 111, find another relay UE, perform a path switch such that the remote 113 UE directly communicates with the gNB 110, or should handover to another cell operated by another gNB. This may be signalled to the remote UE 113 by the gNB 110 in step 144.

Those skilled in the art would appreciate that, in accordance with the example of FIG. 9 and such embodiments of the present technique that relate to this example, the measurements and reporting carried out by the remote UE 113 may not necessarily be changed, but the gNB 110's operation may change such that the gNB 110 ensures whether the remote UE's 113 home PLMN is supported by the target relay UE 112, and takes certain actions if this is not the case.

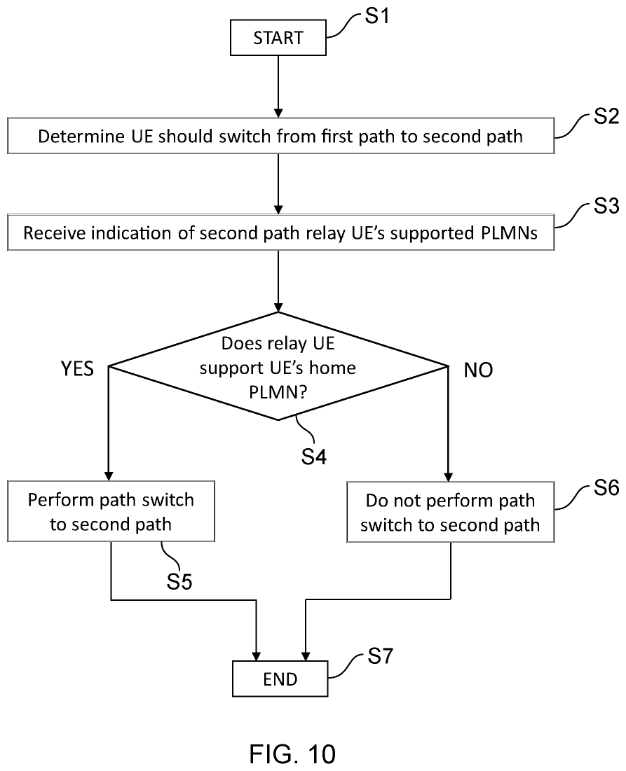

FIG. 10 shows a flow diagram illustrating an example process of communications in a communications system in accordance with embodiments of the present technique. The process shown by FIG. 10 is a method of operating a communications device configured to transmit signals to and/or to receive signals from a first wireless communications network via an infrastructure equipment supporting radio access network, RAN, sharing between a plurality of wireless communications networks comprising the first wireless communications network.

The method begins in step S1. The method comprises, in step S2, determining that the communications device is to switch from a first path of communications with the infrastructure equipment to a second path of communications with the infrastructure equipment, wherein the second path comprises a relay node for relaying signals between the communications device and the infrastructure equipment. In step S3, the process comprises receiving a signal comprising an indication of one or more of the plurality of wireless communications networks that are supported by the relay node of the second path. The method then comprises, in step S4, determining, based on the received indication, if the first wireless communications network is among the one or more wireless communications networks that are supported by the relay node of the second path. If it is determined in step S4 that the first wireless communications network is among the one or more wireless communications networks that are supported by the relay node of the second path, then the method comprises, in step S5, switching from the first path to the second path. On the other hand, if it is determined in step S4 that the first wireless communications network is not among the one or more wireless communications networks that are supported by the relay node of the second path, then the method comprises, in step S6, not switching from the first path to the second path (but rather, for example, switching to a third path, handing over to another infrastructure equipment, or not switching or handing over at all). The process ends in step S7.

Those skilled in the art would appreciate that the method shown by FIG. 10 may be adapted in accordance with embodiments of the present technique as described herein. For example, other intermediate steps may be included in the method, or the steps may be performed in any logical order. Furthermore, though embodiments of the present technique have been described largely by way of the example system shown in FIG. 6, and described by way of the example scenarios and message sequences of FIGS. 7 to 9, it would be clear to those skilled in the art that they could be equally applied to other systems than to those described herein.

Those skilled in the art would further appreciate that such wireless communications networks and/or communications devices as herein defined may be further defined in accordance with the various arrangements and embodiments discussed in the preceding paragraphs. It would be further appreciated by those skilled in the art that such wireless communications networks and communications devices as herein defined and described may form part of communications systems other than those defined by the present disclosure.

The following numbered paragraphs provide further example aspects and features of the present technique:

Paragraph 1. A method of operating a communications device configured to transmit signals to and/or to receive signals from a first wireless communications network via an infrastructure equipment supporting radio access network, RAN, sharing between a plurality of wireless communications networks comprising the first wireless communications network, the method comprising
determining that the communications device is to switch from a first path of communications with the infrastructure equipment to a second path of communications with the infrastructure equipment, wherein the second path comprises a relay node for relaying signals between the communications device and the infrastructure equipment,
receiving a signal comprising an indication of one or more of the plurality of wireless communications networks that are supported by the relay node of the second path,
determining, based on the received indication, if the first wireless communications network is among the one or more wireless communications networks that are supported by the relay node of the second path, and
switching, if the first wireless communications network is among the one or more wireless communications networks that are supported by the relay node of the second path, from the first path to the second path.

Paragraph 2. A method according to Paragraph 1, comprising
receiving, from the relay node of the second path, a discovery signal, wherein the discovery signal comprises the indication of the one or more wireless communications networks that are supported by the relay node of the second path.

Paragraph 3. A method according to Paragraph 2, wherein the indication of the one or more wireless communications networks that are supported by the relay node of the second path is comprised within a radio resource control, RRC, container of the discovery signal.

Paragraph 4. A method according to Paragraph 2 or Paragraph 3, wherein the one or more wireless communications networks that are indicated within the discovery signal as being supported by the relay node of the second path is only a subset of a plurality of wireless communications networks that are supported by the relay node of the second path.

Paragraph 5. A method according to any of Paragraphs 1 to 4, comprising
receiving, from the infrastructure equipment, the indication of the one or more wireless communications networks that are supported by the relay node of the second path.

Paragraph 6. A method according to Paragraph 5, comprising
receiving reference signals from the relay node of the second path,
performing one or more measurements on the received reference signals,
transmitting an indication of the performed one or more measurements to the infrastructure equipment, and
receiving, in response to the transmitted indication of the performed one or more measurements, the indication of the one or more wireless communications networks that are supported by the relay node of the second path.

Paragraph 7. A method according to Paragraph 6, wherein the transmitted indication of the performed one or more measurements comprises a query by the communications device of the one or more wireless communications networks that are supported by the relay node of the second path.

Paragraph 8. A method according to any of Paragraphs 1 to 7, comprising
receiving, from a core network via the infrastructure equipment, the indication of the one or more wireless communications networks that are supported by the relay node of the second path.

Paragraph 9. A method according to any of Paragraphs 1 to 8, comprising
determining, if the first wireless communications network is not among the one or more wireless communications networks that are supported by the relay node of the second path, that the communications device is not to transmit an indication of the relay node of the second path to the infrastructure equipment.

Paragraph 10. A method according to any of Paragraphs 1 to 9, comprising
transmitting to the infrastructure equipment, if the first wireless communications network is not among the one or more wireless communications networks that are supported by the relay node of the second path, an indication of the relay node of the second path.

Paragraph 11. A method according to Paragraph 10, wherein the transmitted indication of the relay node of the second path comprises an indication that the relay node of the second path does not support the first wireless communications network.

Paragraph 12. A method according to any of Paragraphs 1 to 11, comprising
determining, if the first wireless communications network is not among the one or more wireless communications networks that are supported by the relay node of the second path, that the communications device is to switch from the first path to a third path of communications with the infrastructure equipment, wherein the third path comprises a second relay node for relaying signals between the communications device and the infrastructure equipment, the second relay node supporting the first wireless communications network.

Paragraph 13. A method according to any of Paragraphs 1 to 12, comprising
receiving from the infrastructure equipment, if the first wireless communications network is not among the one or more wireless communications networks that are supported by the relay node of the second path, an indication that the communications device is not to switch from the first path to the second path.

Paragraph 14. A method according to any of Paragraphs 1 to 13, comprising
receiving from the infrastructure equipment, if the first wireless communications network is not among the one or more wireless communications networks that are supported by the relay node of the second path, an indication that the communications device is to perform a handover procedure from the infrastructure equipment to a second infrastructure equipment.

Paragraph 15. A method according to any of Paragraphs 1 to 14, wherein the first path comprises direct communications between the communications device and the infrastructure equipment.

Paragraph 16. A method according to any of Paragraphs 1 to 15, wherein the first path comprises a relay node for relaying signals between the communications device and the infrastructure equipment, wherein the first wireless communications network is supported by the relay node of the first path.

Paragraph 17. A communications device comprising
transceiver circuitry configured to transmit signals to and/or to receive signals from an infrastructure equipment supporting radio access network, RAN, sharing between a plurality of wireless communications networks, and
controller circuitry configured in combination with the transceiver circuitry
to determine that the communications device is to switch from a first path of communications with the infrastructure equipment to a second path of communications with the infrastructure equipment, wherein the second path comprises a relay node for relaying signals between the communications device and the infrastructure equipment,
to receive a signal comprising an indication of one or more of the plurality of wireless communications networks that are supported by the relay node of the second path,
to determine, based on the received indication, if the first wireless communications network is among the one or more wireless communications networks that are supported by the relay node of the second path, and
to switch, if the first wireless communications network is among the one or more wireless communications networks that are supported by the relay node of the second path, from the first path to the second path.

Paragraph 18. Circuitry for a communications device, the circuitry comprising
transceiver circuitry configured to transmit signals to and/or to receive signals from an infrastructure equipment supporting radio access network, RAN, sharing between a plurality of wireless communications networks, and
controller circuitry configured in combination with the transceiver circuitry
to determine that the communications device is to switch from a first path of communications with the infrastructure equipment to a second path of communications with the infrastructure equipment. wherein the second path comprises a relay node for relaying signals between the communications device and the infrastructure equipment,
to receive a signal comprising an indication of one or more of the plurality of wireless communications networks that are supported by the relay node of the second path,
to determine, based on the received indication, if the first wireless communications network is among the one or more wireless communications networks that are supported by the relay node of the second path, and
to switch, if the first wireless communications network is among the one or more wireless communications networks that are supported by the relay node of the second path, from the first path to the second path.

Paragraph 19. A method of operating an infrastructure equipment supporting radio access network, RAN, sharing between a plurality of wireless communications networks, the method comprising
transmitting signals to and/or receiving signals from a communications device via a first path of communications with the communications device, the transmitted and/or received signals being signals in accordance with a first of the wireless communications networks,
determining that a second path of communications with the communications device exists, the second path comprises a relay node for relaying signals between the communications device and the infrastructure equipment,
determining, based on an indication received from the relay node of the second path, if the first wireless communications network is among the one or more wireless communications networks that are supported by the relay node of the second path, and
determining, if the first wireless communications network is among the one or more wireless communications networks that are supported by the relay node of the second path, that the communications device is able to switch the from the first path to the second path.

Paragraph 20. A method according to Paragraph 19, comprising
transmitting, to the communications device, an indication of the one or more wireless communications networks that are supported by the relay node of the second path.

Paragraph 21. A method according to Paragraph 20, comprising
receiving, from the communications device, an indication of one or more measurements performed by the communications device on reference signals received from the relay node of the second path, and
transmitting, in response to the received indication of the performed one or more measurements, the indication of the one or more wireless communications networks that are supported by the relay node of the second path.

Paragraph 22. A method according to Paragraph 21, wherein the received indication of the performed one or more measurements comprises a query by the communications device of the one or more wireless communications networks that are supported by the relay node of the second path.

Paragraph 23. A method according to any of Paragraphs 20 to 22, comprises
receiving an indication of the one or more wireless communications networks that are supported by the relay node of the second path from a core network, and
transmitting the received indication of the one or more wireless communications networks that are supported by the relay node of the second path to the communications device.

Paragraph 24. A method according to any of Paragraphs 19 to 23, comprising
receiving from the communications device an indication of the relay node of the second path.

Paragraph 25. A method according to Paragraph 24, wherein the received indication of the relay node of the second path comprises an indication that the relay node of the second path does not support the first wireless communications network.

Paragraph 26. A method according to any of Paragraphs 19 to 25, comprising
determining, if the first wireless communications network is not among the one or more wireless communications networks that are supported by the relay node of the second path, that the communications device will switch from the first path to a third path of communications with the infrastructure equipment, wherein the third path comprises a second relay node for relaying signals between the communications device and the infrastructure equipment, the second relay node supporting the first wireless communications network.

Paragraph 27. A method according to any of Paragraphs 19 to 26, comprising
transmitting to the communications device, if the first wireless communications network is not among the one or more wireless communications networks that are supported by the relay node of the second path, an indication that the communications device is not to switch from the first path to the second path.

Paragraph 28. A method according to any of Paragraphs 19 to 27, comprising
transmitting to the communications device, if the first wireless communications network is not among the one or more wireless communications networks that are supported by the relay node of the second path, an indication that the communications device is to perform a handover procedure from the infrastructure equipment to a second infrastructure equipment.

Paragraph 29. A method according to any of Paragraphs 19 to 28, wherein the first path comprises direct communications between the communications device and the infrastructure equipment.

Paragraph 30. A method according to any of Paragraphs 19 to 29, wherein the first path comprises a relay node for relaying signals between the communications device and the infrastructure equipment, wherein the first wireless communications network is supported by the relay node of the first path.

Paragraph 31. An infrastructure equipment supporting radio access network, RAN, sharing between a plurality of wireless communications networks, the infrastructure equipment comprising
transceiver circuitry configured to transmit signals to and/or to receive signals from a communications device via a first path of communications with the communications device, the transmitted and/or received signals being signals in accordance with a first of the wireless communications networks, and
controller circuitry configured in combination with the transceiver circuitry
to determine that a second path of communications with the communications device exists, the second path comprises a relay node for relaying signals between the communications device and the infrastructure equipment,
to determine, based on an indication received from the relay node of the second path, if the first wireless communications network is among the one or more wireless communications networks that are supported by the relay node of the second path, and
to determine, if the first wireless communications network is among the one or more wireless communications networks that are supported by the relay node of the second path, that the communications device is able to switch the from the first path to the second path.

Paragraph 32. Circuitry for an infrastructure equipment supporting radio access network, RAN, sharing between a plurality of wireless communications networks, the circuitry comprising
transceiver circuitry configured to transmit signals to and/or to receive signals from a communications device via a first path of communications with the communications device, the transmitted and/or received signals being signals in accordance with a first of the wireless communications networks, and
controller circuitry configured in combination with the transceiver circuitry
to determine that a second path of communications with the communications device exists, the second path comprises a relay node for relaying signals between the communications device and the infrastructure equipment,
to determine, based on an indication received from the relay node of the second path, if the first wireless communications network is among the one or more wireless communications networks that are supported by the relay node of the second path, and
to determine, if the first wireless communications network is among the one or more wireless communications networks that are supported by the relay node of the second path, that the communications device is able to switch the from the first path to the second path.

Paragraph 33. A method of operating a relay device configured to transmit signals to and/or to receive signals from one or more communications devices and to transmit signals to and/or to receive signals from an infrastructure equipment supporting radio access network, RAN, sharing between a plurality of wireless communications networks, wherein the relay device supports one or more of the plurality of wireless communications networks, the method comprising
transmitting, to the infrastructure equipment, an indication of the one or more wireless communications networks supported by the relay device, and
determining, if the communications device is connected to one of the one or more wireless communications networks supported by the relay device, that the communications device is to switch from a first path of communications with the infrastructure equipment to a second path of communications with the infrastructure equipment, wherein the second path comprises the relay device, the relay device being configured to relay signals between the communications device and the infrastructure equipment.

Paragraph 34. A method according to Paragraph 33, comprising
transmitting, to the communications device, a discovery signal, wherein the discovery signal comprises an indication of the one or more wireless communications networks that are supported by the relay device.

Paragraph 35. A method according to Paragraph 34, wherein the indication of the one or more wireless communications networks that are supported by the relay device is comprised within a radio resource control, RRC, container of the discovery signal.

Paragraph 36. A method according to Paragraph 34 or Paragraph 35, wherein the one or more wireless communications networks that are indicated within the discovery signal as being supported by the relay device is only a subset of the wireless communications networks that are supported by the relay device.

Paragraph 37. A method according to any of Paragraphs 33 to 36, comprising
receiving, from the communications device, a discovery message, and
transmitting, to the infrastructure equipment, the discovery message received from the communications device.

Paragraph 38. A method according to Paragraph 37, wherein the discovery message received from the communications device and transmitted to the infrastructure equipment comprises an indication of the wireless communications network to which the communications device is connected.

Paragraph 39. A method according to Paragraph 38, comprising
determining whether the wireless communications network to which the communications device is connected is among the one or more wireless communications networks supported by the relay device, and
transmitting to the communications device, if the wireless communications network to which the communications device is connected is not among the one or more wireless communications networks supported by the relay device, a discovery reject message.

Paragraph 40. A relay device comprising
transceiver circuitry configured to transmit signals to and/or to receive signals from one or more communications devices and to transmit signals to and/or to receive signals from an infrastructure equipment supporting radio access network, RAN, sharing between a plurality of wireless communications networks, wherein the relay device supports one or more of the plurality of wireless communications networks, and
controller circuitry configured in combination with the transceiver circuitry
to transmit, to the infrastructure equipment, an indication of the one or more wireless communications networks supported by the relay device, and
to determine, if the communications device is connected to one of the one or more wireless communications networks supported by the relay device, that the communications device is to switch from a first path of communications with the infrastructure equipment to a second path of communications with the infrastructure equipment, wherein the second path comprises the relay device, the relay device being configured to relay signals between the communications device and the infrastructure equipment.

Paragraph 41. Circuitry for a relay device, the circuitry comprising
transceiver circuitry configured to transmit signals to and/or to receive signals from one or more communications devices and to transmit signals to and/or to receive signals from an infrastructure equipment supporting radio access network, RAN, sharing between a plurality of wireless communications networks, wherein the relay device supports one or more of the plurality of wireless communications networks, and
controller circuitry configured in combination with the transceiver circuitry
to transmit, to the infrastructure equipment, an indication of the one or more wireless communications networks supported by the relay device, and
to determine, if the communications device is connected to one of the one or more wireless communications networks supported by the relay device, that the communications device is to switch from a first path of communications with the infrastructure equipment to a second path of communications with the infrastructure equipment, wherein the second path comprises the relay device, the relay device being configured to relay signals between the communications device and the infrastructure equipment.

Paragraph 42. A wireless communications system comprising a communications device according to Paragraph 17 and an infrastructure equipment according to Paragraph 31.

Paragraph 43. A wireless communications system according to Paragraph 42, further comprising a relay device according to Paragraph 40.

Paragraph 44. A computer program comprising instructions which, when loaded onto a computer, cause the computer to perform a method according to any of Paragraphs 1 to 16. Paragraphs 19 to 30, or Paragraphs 33 to 39.

Paragraph 45. A non-transitory computer-readable storage medium storing a computer program according to Paragraph 44.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### References

[1] RP-182090, “Revised SID: Study on NR Industrial Internet of Things (IoT),” 3GPP RAN#81.

[2] Holma H. and Toskala A, “LTE for UMTS OFDMA and SC-FDMA based radio access”, John Wiley and Sons, 2009.

[3] RP-193253, “New SID: Study on NR sidelink relay” (OPPO), December 2019.

[4] TR 36.746, “3^{rd} Generation Partnership Project; Technical Specification Group Radio Access Network; Study on further enhancements to LTE Device to Device (D2D), User Equipment (UE) to network relays for Internet of Things (IoT) and wearables; (Release 15) (version 15.1.1)” (3GPP Organisation), April 2018.

[5] RP-213585, “New WID on NR sidelink relay enhancements” (LG Electronics), December 2021.

[6] 3GPP TR 38.836, “3^{rd} Generation Partnership Project; Technical Specification Group Radio Access Network; Study on NR sidelink relay; (Release 17)” (3GPP Organisation), March 2021.

[7] R2-2111371, “Summary [AT116-3][620][Relay] Reply LS to SA2 on discovery and relay (re)selection,” (CATT), November 2021.

1. A method of operating a communications device configured to transmit signals to and/or to receive signals from a first wireless communications network via an infrastructure equipment supporting radio access network, RAN, sharing between a plurality of wireless communications networks comprising the first wireless communications network, the method comprising
determining that the communications device is to switch from a first path of communications with the infrastructure equipment to a second path of communications with the infrastructure equipment, wherein the second path comprises a relay node for relaying signals between the communications device and the infrastructure equipment,
receiving a signal comprising an indication of one or more of the plurality of wireless communications networks that are supported by the relay node of the second path,
determining, based on the received indication, if the first wireless communications network is among the one or more wireless communications networks that are supported by the relay node of the second path, and
switching, if the first wireless communications network is among the one or more wireless communications networks that are supported by the relay node of the second path, from the first path to the second path.

2. A method according to claim 1, comprising
receiving, from the relay node of the second path, a discovery signal, wherein the discovery signal comprises the indication of the one or more wireless communications networks that are supported by the relay node of the second path.

3. A method according to claim 2, wherein the indication of the one or more wireless communications networks that are supported by the relay node of the second path is comprised within a radio resource control, RRC, container of the discovery signal.

4. A method according to claim 2, wherein the one or more wireless communications networks that are indicated within the discovery signal as being supported by the relay node of the second path is only a subset of a plurality of wireless communications networks that are supported by the relay node of the second path.

5. A method according to claim 1, comprising
receiving, from the infrastructure equipment, the indication of the one or more wireless communications networks that are supported by the relay node of the second path.

6. A method according to claim 5, comprising
receiving reference signals from the relay node of the second path,
performing one or more measurements on the received reference signals,
transmitting an indication of the performed one or more measurements to the infrastructure equipment, and
receiving, in response to the transmitted indication of the performed one or more measurements, the indication of the one or more wireless communications networks that are supported by the relay node of the second path.

7. A method according to claim 6, wherein the transmitted indication of the performed one or more measurements comprises a query by the communications device of the one or more wireless communications networks that are supported by the relay node of the second path.

8. A method according to claim 1, comprising
receiving, from a core network via the infrastructure equipment, the indication of the one or more wireless communications networks that are supported by the relay node of the second path.

9. A method according to claim 1, comprising
determining, if the first wireless communications network is not among the one or more wireless communications networks that are supported by the relay node of the second path, that the communications device is not to transmit an indication of the relay node of the second path to the infrastructure equipment.

10. A method according to claim 1, comprising
transmitting to the infrastructure equipment, if the first wireless communications network is not among the one or more wireless communications networks that are supported by the relay node of the second path, an indication of the relay node of the second path.

11. A method according to claim 10, wherein the transmitted indication of the relay node of the second path comprises an indication that the relay node of the second path does not support the first wireless communications network.

12. A method according to claim 1, comprising
determining, if the first wireless communications network is not among the one or more wireless communications networks that are supported by the relay node of the second path, that the communications device is to switch from the first path to a third path of communications with the infrastructure equipment, wherein the third path comprises a second relay node for relaying signals between the communications device and the infrastructure equipment, the second relay node supporting the first wireless communications network.

13. A method according to claim 1, comprising
receiving from the infrastructure equipment, if the first wireless communications network is not among the one or more wireless communications networks that are supported by the relay node of the second path, an indication that the communications device is not to switch from the first path to the second path.

14. A method according to claim 1, comprising
receiving from the infrastructure equipment, if the first wireless communications network is not among the one or more wireless communications networks that are supported by the relay node of the second path, an indication that the communications device is to perform a handover procedure from the infrastructure equipment to a second infrastructure equipment.

15. A method according to claim 1, wherein the first path comprises direct communications between the communications device and the infrastructure equipment.

16. A method according to claim 1, wherein the first path comprises a relay node for relaying signals between the communications device and the infrastructure equipment, wherein the first wireless communications network is supported by the relay node of the first path.

17. A communications device comprising
transceiver circuitry configured to transmit signals to and/or to receive signals from an infrastructure equipment supporting radio access network, RAN, sharing between a plurality of wireless communications networks, and
controller circuitry configured in combination with the transceiver circuitry
to determine that the communications device is to switch from a first path of communications with the infrastructure equipment to a second path of communications with the infrastructure equipment, wherein the second path comprises a relay node for relaying signals between the communications device and the infrastructure equipment,
to receive a signal comprising an indication of one or more of the plurality of wireless communications networks that are supported by the relay node of the second path,
to determine, based on the received indication, if the first wireless communications network is among the one or more wireless communications networks that are supported by the relay node of the second path, and
to switch, if the first wireless communications network is among the one or more wireless communications networks that are supported by the relay node of the second path, from the first path to the second path.

18.-30. (canceled)

31. An infrastructure equipment supporting radio access network, RAN, sharing between a plurality of wireless communications networks, the infrastructure equipment comprising
transceiver circuitry configured to transmit signals to and/or to receive signals from a communications device via a first path of communications with the communications device, the transmitted and/or received signals being signals in accordance with a first of the wireless communications networks, and
controller circuitry configured in combination with the transceiver circuitry
to determine that a second path of communications with the communications device exists, the second path comprises a relay node for relaying signals between the communications device and the infrastructure equipment,
to determine, based on an indication received from the relay node of the second path, if the first wireless communications network is among the one or more wireless communications networks that are supported by the relay node of the second path, and
to determine, if the first wireless communications network is among the one or more wireless communications networks that are supported by the relay node of the second path, that the communications device is able to switch the from the first path to the second path.

32.-45. (canceled)
